(19) United States
(12) Patent Application Publication
(10) Pub. No.: US 2026/0110585 A1
(43) Pub. Date: Apr. 23, 2026

(54) PHYSICAL QUANTITY DETECTING DEVICE

(71) Applicant: HITACHI ASTEMO, LTD., Hitachinaka-shi, Ibaraki (JP)

(72) Inventors: Takeo HOSOKAWA, Hitachinaka-shi, Ibaraki (JP); Hiroyuki ABE, Hitachinaka-shi, Ibaraki (JP); Atsuo SOMA, Hitachinaka-shi, Ibaraki (JP); Kenji YOSHIHARA, Hitachinaka-shi, Ibaraki (JP); Fumio YUKI, Hitachinaka-shi, Ibaraki (JP)

(73) Assignee: HITACHI ASTEMO, LTD., Hitachinaka-shi, Ibaraki (JP)

(21) Appl. No.: 18/703,881

(22) PCT Filed: Oct. 25, 2021
(86) PCT No.: PCT/JP2021/039376

§ 371 Date: Apr. 23, 2024

(51) Int. Cl. G01L 1/22; G01M 17/02

(52) U.S. Cl. CPC G01L 1/2293; G01M 17/02

(57) ABSTRACT

Provided are a strain detecting element 6a, a base member 6b to which the strain detecting element 6a is fixed, and a holding member 7 that internally holds the base member 6b and has a bottom surface 7a attachable to an inner surface T1 of a tire T. The holding member 7 has a hollow space 7i located on the side closer to the center of the tire T relative to the strain detecting element 6a.

### TECHNICAL FIELD

The present invention relates to a physical quantity detecting device.

### BACKGROUND ART

As a device (physical quantity detecting device) that detects physical quantity relating to the state of a tire, a functional part is disclosed in Patent Document 1. This functional part includes a casing having a housing part of an electronic part that can acquire information concerning the inside of a tire and a bottom surface opposed to the inner circumferential surface of the tire, a cylindrical part (skirt) that extends from the rim of the bottom surface of the casing toward the inner circumferential surface of the tire, and a strain sensor attached to the bottom surface of the casing.

### PRIOR ART DOCUMENT

### Patent Document

Patent Document 1: JP-2020-055402-A

### SUMMARY OF THE INVENTION

### Problem to be Solved by the Invention

It is described that the casing of Patent Document 1 is composed of synthetic resin or the like, and the strain sensor is attached to the bottom surface of the casing (on the side of the tire inner circumferential surface). Thus, there is a possibility that the deformation of the strain Sensor with respect to a force that acts in the direction toward the center of the tire from a road surface with which the tire is in contact is restrained by the casing and the sensitivity of the strain sensor lowers.

An object of the present invention is to provide a physical quantity detecting device that can detect the strain of a tire with high sensitivity.

### Means for Solving the Problem

In order to achieve the above-described object, the present invention includes a strain detecting element, a base member to which the strain detecting element is fixed, and a holding member that internally holds the base member and has a bottom surface attachable to an inner surface of a tire. The holding member has a hollow space located on the side closer to the center of the tire relative to the strain detecting element.

### Advantages of the Invention

According to the present invention, a physical quantity detecting device that can detect the strain of the tire with high sensitivity can be provided. Problems, configurations, and effects other than the above-described ones will be made clear by description of the following embodiments.

### BRIEF DESCRIPTION OF THE DRAWINGS

FIG. 1 is a sectional view of a tire to which a physical quantity detecting device according to a first embodiment of the present invention is attached.

FIG. 2 is a sectional view of the physical quantity detecting device in FIG. 1.

FIG. 3 is a plan view of a strain sensor according to the first embodiment of the present invention.

FIG. 4 is a sectional view taken along line A-A in FIG. 3.

FIG. 5 is a front view of a holding member according to the first embodiment of the present invention.

FIG. 6 is a side view of the holding member according to the first embodiment of the present invention.

FIG. 7 is a sectional view of the holding member to which the strain sensor is attached and that is fixed to an inner surface of the tire by an adhesive, according to the first embodiment of the present invention.

FIG. 8 is a schematic sectional view of comparison between effects of the holding member according to the first embodiment of the present invention and a holding member according to a comparative example.

FIG. 9 is a front view of a holding member according to a second embodiment of the present invention.

FIG. 10 is a side view of the holding member according to the second embodiment of the present invention.

FIG. 11 is a front view of a holding member according to a third embodiment of the present invention.

FIG. 12 is a side view of the holding member according to the third embodiment of the present invention.

FIG. 13 is a front view of a holding member according to a fourth embodiment of the present invention.

FIG. 14 is a side view of the holding member according to the fourth embodiment of the present invention.

FIG. 15 is a sectional view of a physical quantity detecting device according to a fifth embodiment of the present invention.

### MODES FOR CARRYING OUT THE INVENTION

The configurations and operation of physical quantity detecting devices according to first to fifth embodiments of the present invention will be described below with use of the drawings. In the respective diagrams, the same numeral indicates the same part. Further, in each of sectional views, front views, and side views, directions are identified by X-, Y-, and Z-axes orthogonal to each other, and +X, −X, +Y, −Y, +Z, and −Z are defined as “right,” “left” “up,” “down,” “front,” and “rear,” respectively.

### First Embodiment

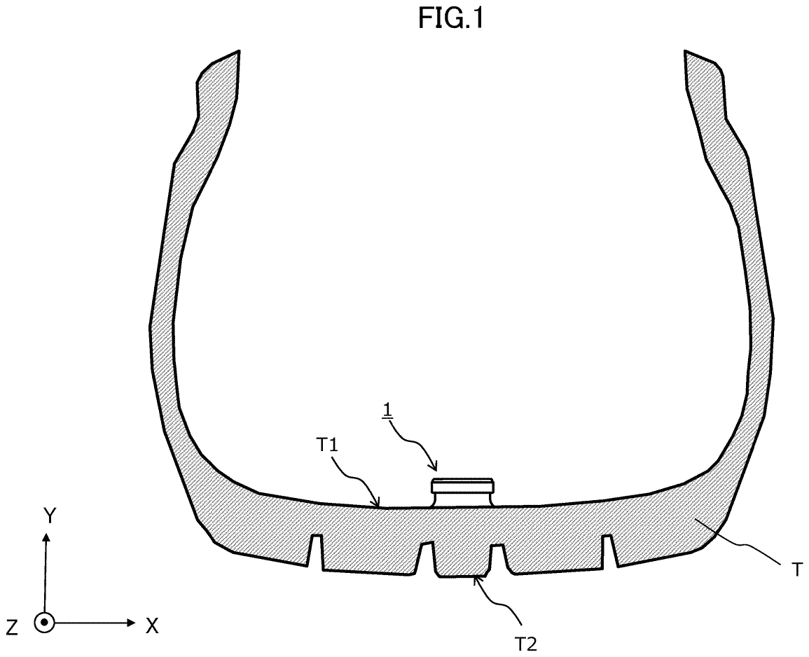

FIG. 1 is a sectional view of a tire T to which a physical quantity detecting device 1 is attached. As illustrated in FIG. 1, the physical quantity detecting device 1 is attached to an inner surface T1 of the tire T of a vehicle and senses physical quantity including the strain of the tire T.

For example, the physical quantity detecting device 1 is fixed to the surface (inner surface T1) of an inner liner formed inside a tread part T2 of the tire T.

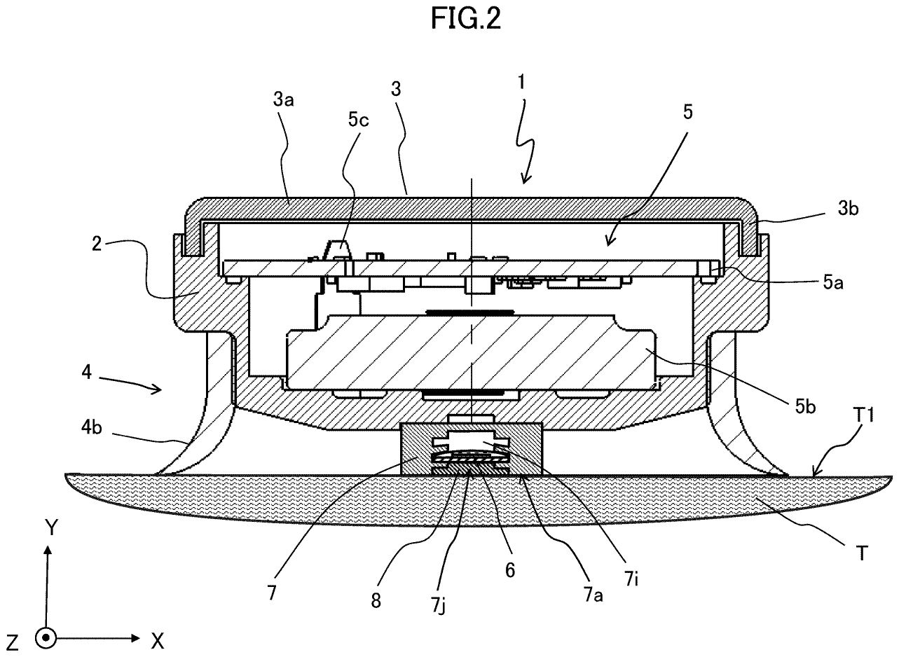

FIG. 2 is a sectional view of the physical quantity detecting device 1 in FIG. 1. As illustrated in FIG. 2, the physical quantity detecting device 1 includes a housing case 2, a cover 3, a skirt 4, a circuit part 5, a strain sensor 6, and a holding member 7 and is fixed to the inner surface T1 of the tire T by an adhesive 8.

The housing case 2 has, for example, a bottomed cylindrical shape that opens upward (+Y direction) and houses the circuit part 5. It is preferable that the housing case 2 be formed of, for example, a synthetic resin for reducing weight and ensuring the strength.

The cover 3 is a lid that closes the opening of the housing case 2 and covers the circuit part 5, and includes a circular plate part 3a and a protruding ridge part 3b extending downward (−Y direction) along the outer circumferential edge of the circular plate part. It is preferable that the cover 3 be also formed of, for example, a synthetic resin for reducing weight and ensuring the strength, similarly to the housing case 2.

The skirt 4 is a component that covers and protects a part that joins the housing case 2 and the inner surface T1 of the tire T and absorbs vibrations of the inner surface T1 of the tire T. For example, the skirt 4 is formed of resin having elasticity. Disposed in the skirt 4 are a cylindrical part 4a fitted to the side circumferential surface of a lower part of the housing case 2 and an enlarged part 4b extending downward (−Y direction) from the cylindrical part 4a in a folding fan shape.

The circuit part 5 is a component that detects physical quantity and transmits the detection result to the external, and includes a circuit board 5a on which electronic parts are mounted, a battery 5b that supplies electricity, and a wiring part 5c that electrically connects the circuit board 5a and the battery 5b.

For example, the circuit board 5a has a sensor that detects the temperature, the atmospheric pressure, the acceleration, and so forth, a transmitting part that transmits a detection value of the sensor to the external of the tire, and a control part that controls them. The battery 5b is, for example, a button battery, is fixed to a bottom part of the housing case 2, and supplies electricity to the circuit board 5a through the wiring part 5c.

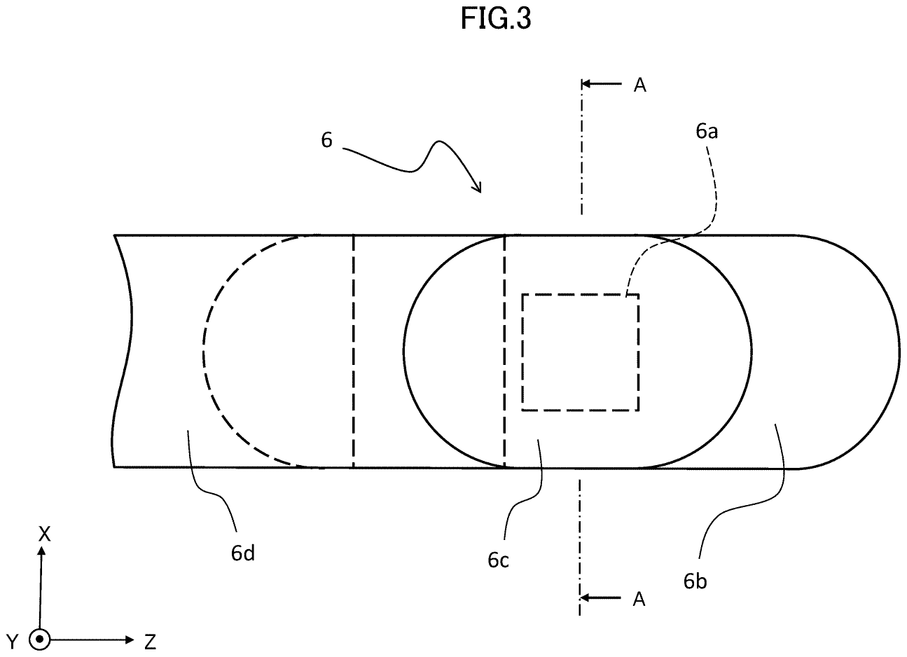

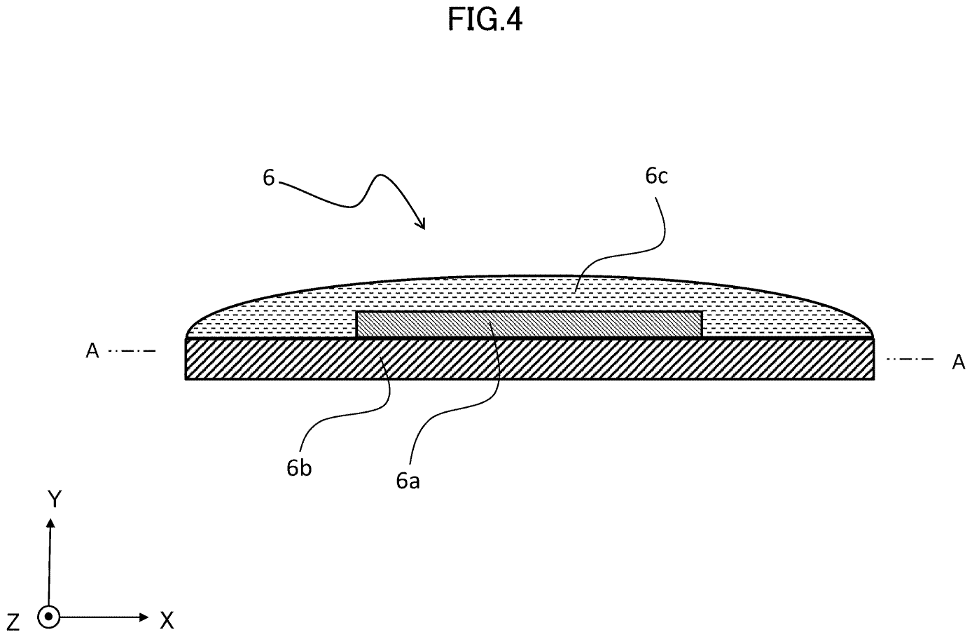

The strain sensor 6 is a component that detects strain and electrically transmits a detection value to the circuit part 5. FIG. 3 is a plan view of the strain sensor 6. FIG. 4 is a sectional view taken along line A-A in FIG. 3. As illustrated in FIG. 3, the strain sensor 6 includes a strain detecting element 6a, a base member 6b, a sealing part 6c, and an electrical wire part 6d.

The strain detecting element 6a is a semiconductor that outputs a strain amount corresponding to change in the resistance and is, for example, a semiconductor strain sensor obtained by making a sensor element and a control circuit into one chip.

The semiconductor strain sensor is an IC chip manufactured by a semiconductor process and is, for example, a rectangular MOSFET sensor chip with a size of approximately 5 mm×5 mm. Further, for example, the semiconductor strain sensor is configured by a semiconductor formed by a CMOS process and micro electro mechanical systems (MEMS). When the strain sensor is large, there is a possibility that the strain sensor breaks when the tire runs onto a foreign object. Thus, it is preferable that the semiconductor stain sensor be smaller than 5 mm×5 mm. The strain detecting element 6a is not limited to the semiconductor strain sensor, and a strain gauge may be used, for example.

The base member 6b is a member that fixes the strain detecting element 6a and is, for example, a thin plate made of metal having a linear expansion coefficient close to that of a semiconductor material (Si or the like) that forms the strain detecting element 6a. As the metal having a linear expansion coefficient close to that of the semiconductor material (Si or the like), for example, 42 Alloy (alloy made by mixing nickel with iron) having a linear expansion coefficient of approximately 5 ppm/° C., whose difference from a linear expansion coefficient of approximately 4 ppm/° C. regarding silicon (Si) is approximately 1 ppm/° C. can be used.

By using the metal having a linear expansion coefficient close to that of the semiconductor material as the material of the base member 6b as described above, the accuracy of sensing of strain by the strain detecting element 6a can be improved.

Moreover, the base member 6b is not limited to the above-described metal. For example, metal having corrosion resistance against a sulfur gas generated from the tire T (stainless steel, aluminum, copper, iron-based alloy, base metal for which plating treatment of gold, nickel, tin, or the like has been executed, or the like) may be used.

The base member 6b is a rectangular thin plate in order to allow the holding member 7 to easily hold the base member 6b and accurately transmit the strain of the tire to the strain detecting element 6a. Furthermore, an end part in the +Z direction (front side) in the base member 6b has a circular arc shape as illustrated in FIG. 3 in order to facilitate insertion into the holding member 7. The shape of the base member 6b is not limited to the above description and may be a circular shape, an ellipsoidal shape, or another polygonal shape.

The strain detecting element 6a is fixed to a surface (surface on the +Z side) of the base member 6b by an adhesive, for example, an epoxy-based adhesive with high hardness.

The sealing part 6c is resin, for example, epoxy resin, applied to the surface of the base member 6b from above a bonding wire (not illustrated) that electrically connects the strain detecting element 6a and the electrical wire part 6d and the strain detecting element 6a. By the sealing part 6c, the strain detecting element 6a and the bonding wire are sealed to be protected from an external environment. The sealing part 6c is not limited to the epoxy resin, and other resin, for example, urethane resin or silicone resin, may be used.

The electrical wire part 6d is an electrical wire that electrically connects the strain detecting element 6a and the circuit part 5 and is, for example, a flexible printed wiring board (Flexible printed circuits: FPC).

The holding member 7 is a component that internally holds the base member 6b of the strain sensor 6 and has a bottom surface 7a attachable to the inner surface T1 of the tire T. Moreover, it is preferable that the holding member 7 be formed of, for example, cushion rubber having an elastic modulus approximately equal to or lower than that of the tire T. An upper part of the holding member 7 is fixed to the lower part of the housing case 2 by an adhesive, for example.

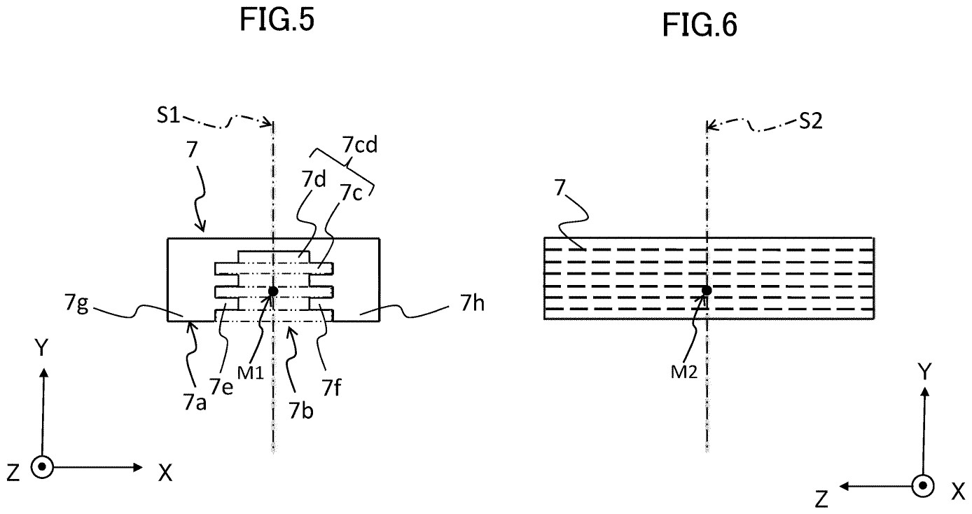

FIG. 5 is a front view of the holding member 7 according to the first embodiment of the present invention. FIG. 6 is a side view of the holding member 7 according to the first embodiment 44 the present invention. As illustrated in FIGS. 5 and 6, the holding member 7 is a member with a quadrangular prism shape that is long in the front-rear direction (Z-axis direction), and includes a holding part 7b that holds the base member 6b of the strain sensor 6 and leg parts 7g and 7h that support the base member 6b.

The holding part 7b is a groove that is provided at the center of the holding member 7 in the left-right direction (X-axis direction), opens toward the lower side of the holding member 7 (−Y direction), and extends in the front-rear direction of the holding member 7 (Z-axis direction). The holding part 7b includes a plurality of holding groove parts 7cd having a first groove part 7c into which the base member 6b is inserted and a second groove part 7d that is provided on the upper side of the first groove part 7c and forms a hollow space above the strain detecting element 6a.

Specifically, the width of the first groove part 7c in the X-axis direction is longer than that of the base member 6b in the X-axis direction in order to allow insertion of the base member 6b of the strain sensor 6. Moreover, on the upper and lower sides of the first groove part 7c, protruding ridges 7e and 7f for holding the base member 6b protrude in the X-axis direction from the side surfaces of the left and right leg parts 7g and 7h on the side of the holding part 7b and extend in the Z-axis direction. Thus, the second groove part 7d is shorter than the first groove part 7c in the X-axis direction. In addition, a plurality of (in the present embodiment, three) holding groove parts 7cd are formed in the Y-axis direction in the holding part 7b, and the appropriate holding groove part 7cd can be selected depending on the kind of tire T or the kind of vehicle.

Further, in the holding part 7b of the holding member 7, the first groove parts 7c and the protruding ridges 7e and 7f are formed in such a manner that the distance between the bottom surface 7a and the strain sensor 6 (specifically, the base member 6b) becomes approximately constant. That is, the first groove parts 7c and the second groove parts 7d (holding groove parts 7cd) are formed along the bottom surface 7a with a predetermined width in the Y-axis direction.

Moreover, the holding member 7 has the leg parts 7g and 7g that can come into contact with the inner surface T1 of the tire T on the side of the bottom surface 7a of both ends in the width direction (X-axis direction). It is preferable that the shape of the leg parts 7g and 7h be made into a shape (for example, a rectangular parallelepiped shape) approximately perpendicularly extending from the bottom surface 7a toward the upper side (in other words, in the direction toward the center of the tire T when the holding member 7 is attached to the tire T).

Further, as illustrated in FIG. 5, when an orthogonal coordinate system is defined by the X-axis (first axis) extending in the width direction of the holding member 7, the Z-axis (third axis) that is orthogonal to the X-axis and extends in the depth direction of the holding member 7, and the Y-axis (second axis) extending in the direction orthogonal to the X-axis and the Z-axis, it is preferable that the shapes of the leg parts 7g and 7h be made plane-symmetric with respect to a plane S1 arising from translation of the plane defined by the Y-axis and the Z-axis (YZ-plane) to the position passing through a midpoint M1 of the holding part 7b in the X-axis direction.

Moreover, as illustrated in FIG. 6, when an orthogonal coordinate system is defined by the X-axis (first axis) extending in the width direction of the holding member 7, the Z-axis (third axis) that is orthogonal to the X-axis and extends in the depth direction of the holding member 7, and the Y-axis (second axis) extending in the direction orthogonal to the X-axis and the Z-axis, it is preferable that the shapes of the leg parts 7g and 7h be made plane-symmetric with respect to a plane S2 arising from translation of the plane defined by the X-axis and the Y-axis (XY-plane) to the position passing through a midpoint M2 of the holding part 7b in the Z-axis direction.

As illustrated in FIG. 2, the upper part of the holding member 7 that internally holds the base member 6b is fixed to the lower part of the housing case 2 by an adhesive, and the bottom surface 7a is attached to the inner surface T1 of the tire T.

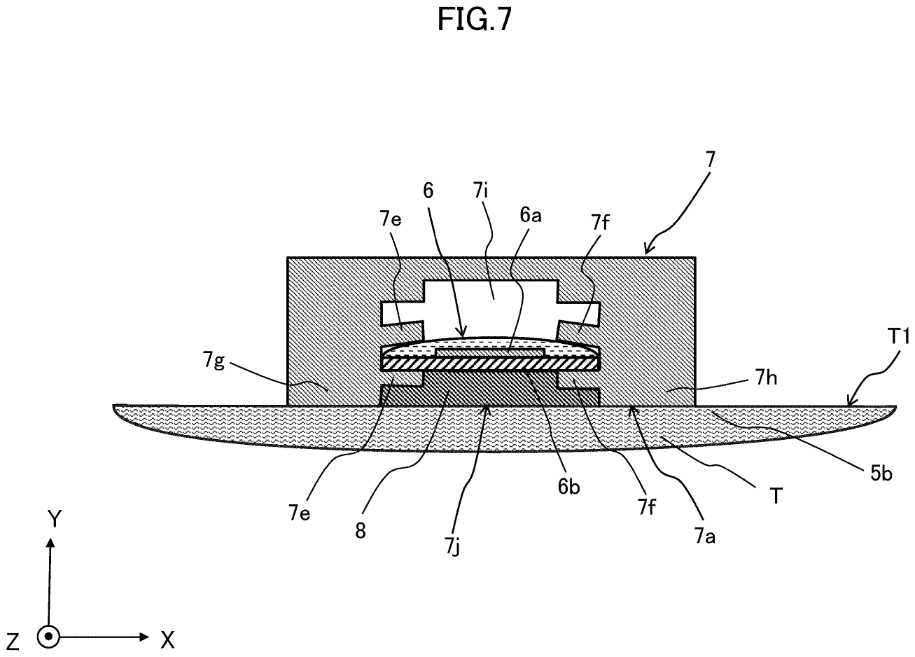

FIG. 7 is a sectional view of the holding member 7 to which the strain sensor 6 is attached and that is fixed to the inner surface T1 of the tire T by the adhesive 8, according to the present embodiment of the present invention. In the present embodiment, the strain sensor 6 is attached to the central holding groove part 7cd in the three holding groove parts 7cd arranged in the Y-axis direction.

The holding member 7 attached to the inner surface T1 of the tire T has a hollow space 7i located on the side closer to the center of the tire T relative to the strain detecting element 6a. The hollow space 7i of the present embodiment is formed by the second groove part 7d above the first groove part 7c into which the base member 6b is inserted and one holding groove part 7cd located above them. When the strain sensor 6 is attached to the holding groove part 7cd at the upper end in the three holding groove parts 7cd arranged in the Y-axis direction, the hollow space 7i is formed by only the second groove part 7d above the first groove part 7c into which the base member 6b is inserted.

Moreover, when the strain sensor 6 is attached to the holding groove part 7cd at the lower end in the three holding groove parts 7cd arranged in the Y-axis direction, the hollow space 7i is formed by the second groove part 7d above the first groove part 7c into which the base member 6b is inserted and the two holding groove parts 7cd located above them. Hence, the size of the hollow space 7i varies depending on the position of the first groove part 7c into which the base member 6b is inserted.

Moreover, it is preferable that a space 7j that can be filled with an adhesive be formed between the base member 6b and the inner surface T1 of the tire T in the state in which the bottom surface 7a is attached to the inner surface T1 of the tire T. Hence, it is preferable to attach the strain sensor 6 to the holding groove part 7cd on the upper side relative to the holding groove part 7cd at the lower end. It is preferable to use an adhesive having an elastic modulus approximately equal to or higher than the elastic modulus of the tire T as the adhesive 8 with which the space 7j is filled.

The base member 6b and the holding member 7 are fixed to the inner surface T1 of the tire T through filling of the space 7j with the adhesive 8. As the adhesive 8, a rubber-based elastic adhesive suitable for the adhesiveness with the tire and the hardness of the tire, for example, a silicone-based or urethane-based adhesive, is preferable.

Expressions of approximately equal, approximately constant, approximately perpendicular, and approximately the center do not limit the strictly equal, constant, and perpendicular states and permit such a range including the manufacturing tolerance, the design tolerance, and an error due to accumulation of them, and can be translated into also substantially equal, constant, perpendicular, and the center.

### Effects

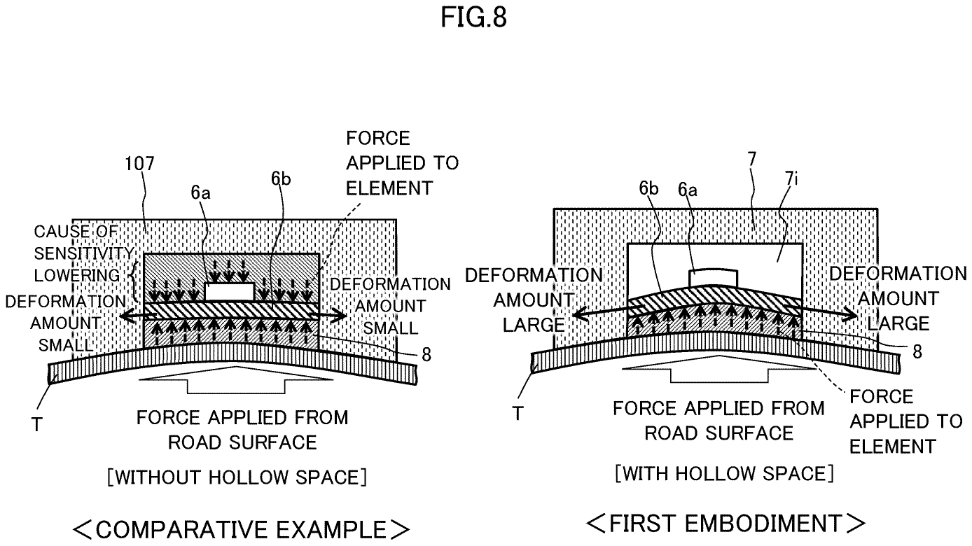

FIG. 8 is a schematic sectional view of comparison between effects of the holding member 7 according to the present embodiment and a holding member 107 according to a comparative example.

In the holding member 107 according to the comparative example, a space located on the side closer to the center of the tire T relative to the strain detecting element 6a is filled with an object such as an adhesive, for example. Thus, the holding member 107 does not include the hollow space 7i of the present embodiment. When a force is applied from a road surface in this case, a force (force from the upper side toward the lower side in the diagram) acts on the strain detecting element 6a from the tire center side as a cause of sensitivity lowering of the strain detecting element 6a, and the deformation of the base member 6b is impeded. Thus, there is a possibility that the sensitivity of the strain detecting element 6a lowers.

In contrast, the holding member 7 of the present embodiment has the hollow space 7i located on the side closer to the center of the tire T relative to the strain detecting element 6a. In this case, the force that acts on the strain detecting element 6a from the tire center side (cause of sensitivity lowering) is eliminated. Thus, the base member 6b can easily be deformed compared with the case in which the hollow space 7i is absent, and the force applied from the road surface can be detected by the strain detecting element 6a with high sensitivity.

Further, it is preferable for the holding member 7 to include the holding part 7b that holds the base member 6b in such a manner that the distance between the bottom surface 7a (tire inner surface T1) and the base member 6b is approximately constant. When the holding member 7 including the holding part 7b in this manner is attached to the tire inner surface T1 with filling of the space 7j below the base member 6b with an adhesive, the occurrence of variation in the distance between the base member 6b (strain detecting element 6a) and the tire inner surface T1 can be suppressed. As a result, the degree of damping transmitted from the deformation strain of the tire T to the strain detecting element 6a through the adhesive becomes constant, and the strain can be accurately sensed.

Moreover, it is preferable that the holding member 7 be formed of cushion rubber having an elastic modulus approximately equal to or lower than that of the tire T and the elastic modulus of the adhesive 8 with which the space 7j between the base member 6b and the inner surface T1 of the tire T is filled be set approximately equal to or higher than that of the tire T. When the elastic modulus of each of the holding member 7 and the adhesive 8 is adjusted in this manner, a force applied from the tire T (road surface) to the holding member 7 is absorbed by the holding member 7, and transmission thereof to the housing case 2 is suppressed, whereas the adhesive 8 is easily deformed in such a manner as to follow the force applied from the tire T (road surface) and can easily transmit this deformation to the base member 6b (strain detecting element 6a). That is, sensitivity lowering of the strain detecting element 6a attributable to restraint on the base member 6b by the holding member 7 can be reduced. In addition, the deformation of the adhesive 8 can be accurately sensed by the strain detecting element 6a. Thus, strain applied to the tire T can be accurately sensed.

Further, it is preferable for the holding member 7 to have the leg parts 7g and 7h that are located at both ends in the width direction (X-axis direction) and that approximately perpendicularly extend from the bottom surface 7a. In this case, when the holding member 7 is bonded to the inner surface T1 of the tire T, dispersion of the force that presses the holding member 7 against the inner surface T1 in the direction of the tangent to the inner surface T1 is suppressed, and variation in the distance between the inner surface T1 of the tire T and the base member 6b can be suppressed. As a result, variation in the thickness of the adhesive 8 is suppressed, and a detection error of strain caused by the variation in the thickness of the adhesive 8 decreases. Thus, the strain of the tire T can be accurately detected.

When an orthogonal coordinate system is defined by the X-axis (first axis) extending in the width direction of the holding member 7, the Z-axis (third axis) that is orthogonal to the X-axis and extends in the depth direction of the holding member 7, and the Y-axis (second axis) extending in the direction orthogonal to the X-axis and the Z-axis, it is preferable that the shapes of the leg parts 7g and 7h be made plane-symmetric with respect to the plane S1 arising from translation of the plane defined by the Y-axis and the Z-axis (YZ-plane) to the position passing through the midpoint M1 of the holding part 7b in the X-axis direction.

When the leg parts 7g and 7h are made into such shapes, variation in the distance between the inner surface T1 of the tire T and the base member 6b in the width direction of the holding member 7 can be suppressed. That is, variation in the thickness of the adhesive 8 is suppressed, and a detection error of strain decreases. Thus, the strain of the tire T can be accurately detected.

Moreover, when an orthogonal coordinate system is defined by the X-axis (first axis) extending in the width direction of the holding member 7, the Z-axis (third axis) that is orthogonal to the X-axis and extends in the depth direction of the holding member 7, and the Y-axis (second axis) extending in the direction orthogonal to the X-axis and the Z-axis, the shapes of the leg parts 7g and 7h may be made plane-symmetric with respect to the plane S2 arising from translation of the plane defined by the X-axis and the Y-axis (XY-plane) to the position passing through the midpoint M2 of the holding part 7b in the Z-axis direction.

When the leg parts 7g and 7h are made into such shapes, variation in the distance between the inner surface T1 of the tire T and the base member 6b in the depth direction of the holding member 7 can be suppressed. That is, variation in the thickness of the adhesive 8 is suppressed, and a detection error of strain decreases. Thus, the strain of the tire T can be accurately detected.

Further, the strain detecting element 6a is a semiconductor that outputs a strain amount corresponding to change in the resistance, for example, a semiconductor strain sensor. This allows measurement with low power consumption (for example, approximately 1/1000) but high sensitivity (for example, approximately 25000 times) compared with the strain gauge.

### Second Embodiment

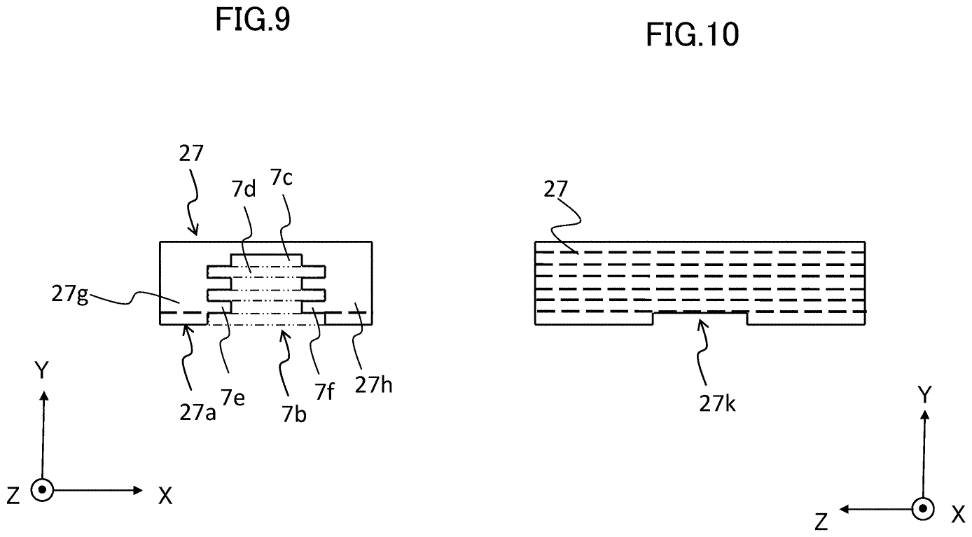

FIG. 9 is a front view of a holding member according to the second embodiment of the present invention. Further, FIG. 10 is a side view of the holding member according to the second embodiment of the present invention.

A difference of a holding member 27 according to the present embodiment from the holding member 7 according to the first embodiment is that the holding member 27 has slits 27k that cause the inside and the outside of the space 7j (see FIG. 7) to communicate in a bottom surface 27a of the holding member 27.

For example, the slits 27k are recessed parts that are provided at the center of leg parts 27g and 27h in the Z-axis direction, open to the lower side of the leg parts 27g and 27h, extend in the X-axis direction of the leg parts 27g and 27h, and have the same width in the Y-axis direction as the second groove part 7d.

### Effects

The slits 27k that cause the inside and the outside (for example, side surface of the holding member 27) of the space 7j to communicate are provided in the bottom surface 27a of the holding member 27. Thus, when the space 7j of the holding member 27 is filled with the adhesive 8 and the holding member 27 is pressed against the inner surface T1 of the tire T for the purpose of attaching a physical quantity detecting device 21 to the inner surface T1 of the tire T, the extra adhesive 8 can be allowed to escape from the space 7j to the slits 27k. As a result, the holding member 27 can be bonded to the tire without application of a force greater than necessary to the base member 6b. In addition, the occurrence of variation in the distance between the base member 6b and the tire inner surface T1 can be suppressed. Thus, strain can be accurately sensed. Moreover, the area of bonding of the holding member 27 to the inner surface T1 of the tire T can be enlarged.

Although the slits 27k are provided in the bottom surface 27a of the holding member 27 as the escape part of the extra adhesive 8 in the present embodiment, it is also possible to make through-holes that cause the inside and the outside of the space 7j to communicate in the side surfaces of the holding member 27 instead of the slits 27k. However, in this case, there is a possibility that the through-holes in the side surfaces of the holding member 27 are filled with the adhesive with a lower elastic modulus than the holding member 27 and the elastic modulus of the holding member 27 is suppressed. Furthermore, it is impossible to enlarge the area of bonding of the holding member 27 to the inner surface T1 of the tire T.

### Third Embodiment

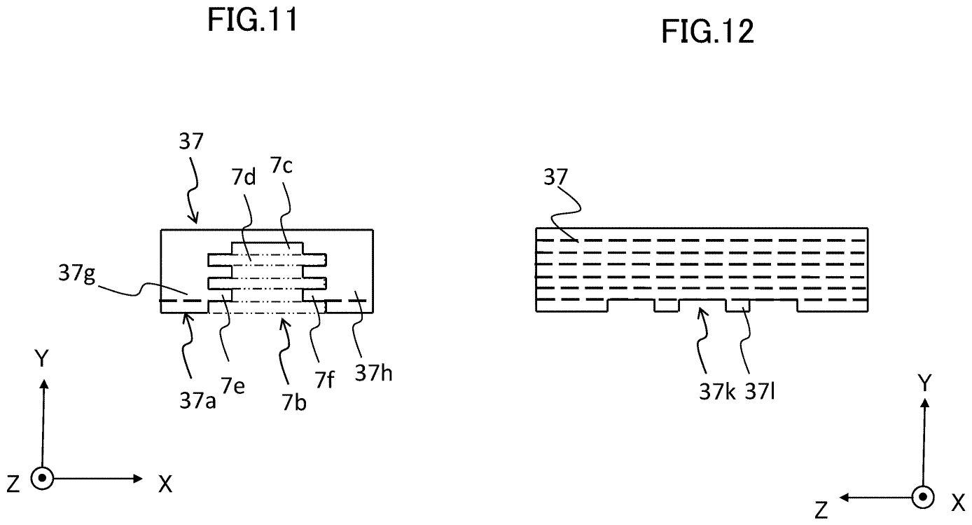

FIG. 11 is a front view of a holding member according to the third embodiment of the present invention. Further, FIG. 12 is a side view of the holding member according to the third embodiment of the present invention.

A difference of a holding member 37 according to the present embodiment from the holding member 27 according to the second embodiment is that slits that cause the inside and the outside of the space 7j (see FIG. 7) to communicate are formed in a bottom surface 37a of the holding member 37 by one or more (in the present embodiment, three in the bottom surface 37a of each of leg parts 37g and 37h) recessed parts 37k.

Moreover, the width in the Z-axis direction regarding each recessed part 37k of the present embodiment is smaller than the width in the Z-axis direction regarding the slit 27k of the second embodiment, and a protruding part 371 is formed between two recessed parts 37k adjacent to each other.

### Effects

The slits that cause the inside and the outside of the space 7j (see FIG. 2) to communicate are formed in the bottom surface 37a of the holding member 37 by the one or more (in the present embodiment, three in the bottom surface 37a of each of the leg parts 37g and 37h) recessed parts 37k. Thus, for example, when a force (for example, stress) along the direction in which the plurality of recessed parts 37k are arranged acts on the holding member 37, the holding member 37 can be supported with this force being dispersed by the plurality of recessed parts 37k. As a result, compared with the case in which the recessed parts 37k are absent, the load that acts on the strain sensor 6 due to repetition of the deformation of the tire T or shock when the tire T runs onto a protruding object can be dispersed, and the durability of the strain sensor 6 can be improved. Moreover, the area of bonding of the holding member 37 to the inner surface T1 of the tire T can be further enlarged.

### Fourth Embodiment

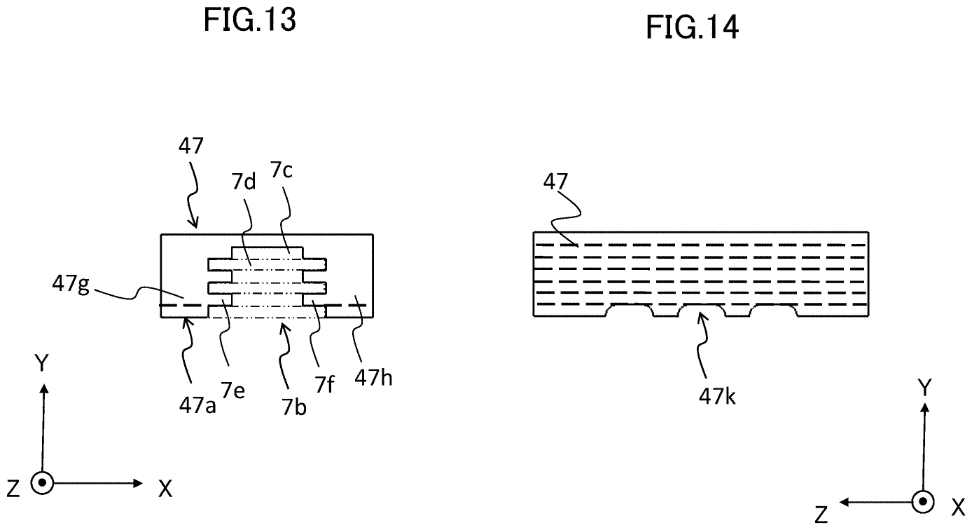

FIG. 13 is a front view of a holding member according to the fourth embodiment of the present invention. Further, FIG. 14 is a side view of the holding member according to the fourth embodiment of the present invention.

A difference of a holding member 47 according to the present embodiment from the holding member 37 according to the third embodiment is that curved surfaces are formed at corner parts located at the bottoms of one or more recessed parts 47k that configure slits.

### Effects

The curved surfaces are formed at the corner parts located at the bottoms of the one or more recessed parts 47k that configure the slits. Thus, the holding member 47 can be supported with further dispersion of the force that acts on the holding member 37 from the inner surface T1 of the tire T through the adhesive 8. This can disperse the load on the strain sensor 6 caused by repetition of the deformation of the tire T or shock when the tire T runs onto a protruding object, and further improve the durability.

### Fifth Embodiment

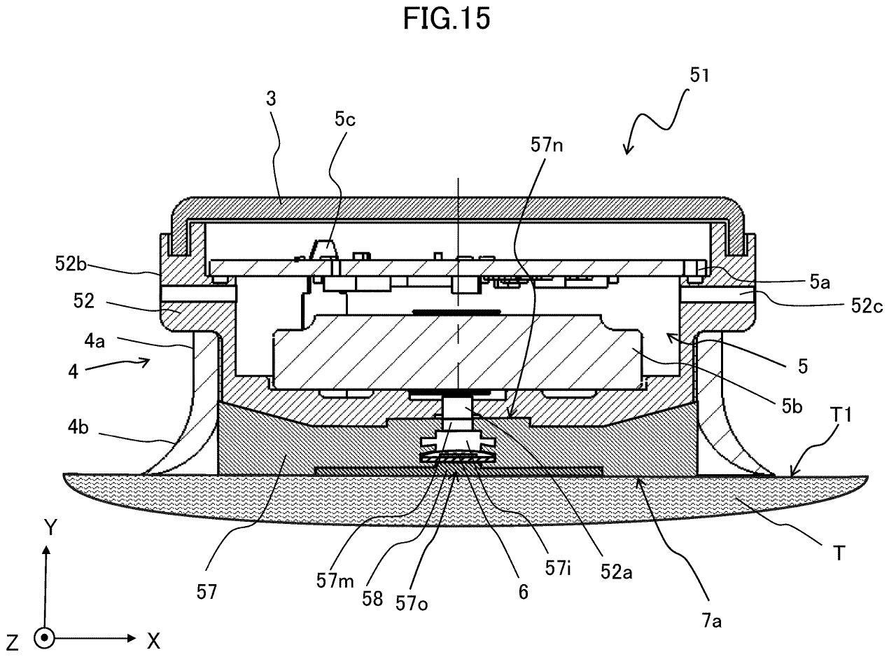

FIG. 15 is a sectional view of a physical quantity detecting device according to the fifth embodiment of the present invention. A difference of a physical quantity detecting device 51 according to the present embodiment from the physical quantity detecting device 1 according to the first embodiment is that through-holes 57m, 52a, and 52c that cause a hollow space 57i of a holding member 57 and the inside of the tire T to communicate are provided in a housing case 52 joined to the holding member 57 and a part 57n joined to the housing case 52 in the holding member 57.

Specifically, the through-hole 57m is provided in the part 57n joined to the housing case 52 in the holding member 57 above the hollow space 57i. Further, the through-hole 52a that causes the through-hole 57m of the holding member 57 and the inside of the housing case 52 to communicate is made in a lower part to which the holding member 57 is joined in the housing case 52. Moreover, the through-hole 52c that causes the inside of the housing case 52 and the inside of the tire T to communicate is provided in a side surface 52b of the housing case 52. Thus, the hollow space 57i and the inside of the tire T communicate by the through-holes 57m, 52a, and 52c.

The holding member 57 of the present embodiment is larger than the holding members 7 to 47 of the first to fourth embodiments, and a holding part 57b does not penetrate the holding member 57 in the front-rear direction (Z direction) and is closed. Moreover, a first groove part 57c of a lowermost holding groove part 57cd of the holding part 57b of the holding member 57 has a large area of the XZ-plane compared with the first groove parts 57c of the holding groove parts 57cd on the upper side.

### Effects

The holding member 57 and the housing case 52 have the through-holes 57m, 52a, and 52c that cause the hollow space 57i and the inside of the tire T to communicate. Thus, generation of a pressure difference between the hollow space 57i and the inside of the tire can be suppressed, and the occurrence of a detection error through working of a force on the strain sensor 6 due to the pressure difference can be suppressed.

Specifically, when the strain sensor 6 is disposed in a sealed space, there is a possibility that a pressure difference is caused between the inside of the tire T and the hollow space 57i due to change in the air pressure of the tire T attributable to temperature change or the like and a force is applied to the strain sensor 6 to lower the detection accuracy. In the present embodiment, the through-holes 57m, 52a, and 52c that cause the hollow space 57i of the holding member 57 and the inside of the tire T to communicate are provided in the housing case 52 joined to the holding member 57 and the part 57n joined to the housing case 52 in the holding member 57. This can eliminate the pressure difference between the inside of the tire T and the hollow space 57i. Thus, a force applied to the strain sensor 6 due to the pressure difference can be eliminated, and strain can be accurately detected.

The present invention is not limited to the above-described embodiments, and various modification examples are included therein. For example, the above-described embodiments are those that are described in detail in order to explain the present invention in an easy-to-understand manner and are not necessarily limited to those that include all configurations described. Moreover, it is possible to replace part of a configuration of a certain embodiment by a configuration of another embodiment. Further, it is also possible to add a configuration of a certain embodiment to a configuration of another embodiment. In addition, regarding part of a configuration of each embodiment, addition, deletion, or substitution of another configuration can be executed.

### DESCRIPTION OF REFERENCE CHARACTERS

1, 21, 51: Physical quantity detecting device
2: Housing case
6: Strain sensor
6a: Strain detecting element
6b: Base member
7, 27, 37, 47, 57: Holding member
7a, 27a, 37a: Bottom surface
7b, 57b: Holding part
7c: First groove part
7d: Second groove part
7e, 7f: Protruding ridge
7g, 7h, 27g, 27h, 37g, 37h: Leg part
71, 57i: Hollow space
7j: Space
8: Adhesive
27k: Slit
37k, 47k: Recessed part
52: Housing case
52a, 52c, 57m: Through-hole

1. A physical quantity detecting device comprising:
a strain detecting element;
a base member to which the strain detecting element is fixed; and
a holding member that internally holds the base member and has a bottom surface attachable to an inner surface of a tire, wherein
the holding member has a hollow space located on a side closer to a center of the tire relative to the strain detecting element.

2. The physical quantity detecting device according to claim 1, wherein
the holding member includes a holding groove part that holds the base member in such a manner that a distance between the bottom surface and the base member is approximately constant.

3. The physical quantity detecting device according to claim 1, wherein,
in a state in which the bottom surface is attached to the inner surface of the tire,
a space allowed to be filled with an adhesive is formed between the base member and the inner surface of the tire in the holding member, and
a slit that causes the space and outside of the holding member to communicate is provided in the bottom surface.

4. The physical quantity detecting device according to claim 1, wherein
the holding member is formed of cushion rubber having an elastic modulus approximately equal to or lower than an elastic modulus of the tire, and
an elastic modulus of an adhesive with which a space between the base member and the inner surface of the tire in the holding member is filled is approximately equal to or higher than the elastic modulus of the tire.

5. The physical quantity detecting device according to claim 1, wherein
the holding member has leg parts that are located at both ends in a width direction and approximately perpendicularly extend from the bottom surface.

6. The physical quantity detecting device according to claim 5, wherein,
when an orthogonal coordinate system is defined by a first axis extending in the width direction of the holding member, a third axis that is orthogonal to the first axis and extends in a depth direction of the holding member, and a second axis extending in a direction orthogonal to the first axis and the third axis,
shapes of the leg parts are plane-symmetric with respect to a plane arising from translation of a plane defined by the second axis and the third axis to a position passing through a midpoint of the holding member in a first axis direction.

7. The physical quantity detecting device according to claim 5, wherein,
when an orthogonal coordinate system is defined by a first axis extending in the width direction of the holding member, a third axis that is orthogonal to the first axis and extends in a depth direction of the holding member, and a second axis extending in a direction orthogonal to the first axis and the third axis,
shapes of the leg parts are plane-symmetric with respect to a plane arising from translation of a plane defined by the first axis and the second axis to a position passing through a midpoint of the holding member in a third axis direction.

8. The physical quantity detecting device according to claim 3, wherein
the slit is formed of one or more recessed parts.

9. The physical quantity detecting device according to claim 8, wherein
curved surfaces are formed at corner parts located at bottoms of the one or more recessed parts.

10. The physical quantity detecting device according to claim 1, wherein
through-holes that cause the hollow space and inside of the tire to communicate are provided in a housing case joined to the holding member and a part joined to the housing case in the holding member.

11. The physical quantity detecting device according to claim 1, wherein
the strain detecting element is a semiconductor and outputs a strain amount corresponding to change in resistance.
